(19) United States
(12) Patent Application Publication
(10) Pub. No.: US 2025/0230803 A1
(43) Pub. Date: Jul. 17, 2025

(54) ION THRUSTER

(71) Applicant: The Charles Stark Draper Laboratory, Inc., Cambridge, MA (US)

(72) Inventors: Katharine Oleske, Cambridge, MA (US); Jonathan David Rameau, Somerville, MA (US)

(21) Appl. No.: 19/018,219

(22) Filed: Jan. 13, 2025

Related U.S. Application Data
(60) Provisional application No. 63/619,991, filed on Jan. 11, 2024.

(51) Int. Cl. F03H 1/00; H05H 7/22

(52) U.S. Cl. CPC F03H 1/0037; H05H 7/22

(57) ABSTRACT

A system for generating thrust includes a thruster body having a funnel and an ion accelerator. The funnel has an opening at a first end of the thruster body and is configured to receive neutral particles and cause ionization of the neutral particles, resulting in corresponding ions and electrons. The ion accelerator extends from the funnel to a second end of the thruster body and is configured to receive the ionized particles from the funnel and cause ejection of the ionized particles from an opening at the second end of the thruster body, generating thrust.

### CROSS-REFERENCES TO RELATED APPLICATIONS

This application claims the benefit of U.S. Provisional Application No. 63/619,991 filed Jan. 11, 2024, the entire contents of which are incorporated herein by reference.

### BACKGROUND OF THE INVENTION

This invention relates to ion thrusters.

Ion thrusters are advanced propulsion systems that use electrically charged particles (i.e., ions) to generate thrust. By ionizing a propellant gas such as xenon and accelerating the resulting ions using electric or electromagnetic fields, ion thrusters achieve high specific impulse, making them suitable for applications such as satellite station-keeping, deep-space exploration, and orbital transfers.

### SUMMARY OF THE INVENTION

While conventional ion thrusters offer significant advantages over traditional chemical propulsion systems in terms of fuel efficiency and extended operational lifetimes, challenges remain in optimizing their thrust-to-power ratio, reducing erosion of critical components of the thrusters, and improving overall reliability under extended operating conditions.

Aspects described herein relate to an air-breathing, fuel-agnostic ion thruster design that uses a radio frequency (RF) ionizer funnel and electrostatic linear ion accelerator to provide potentially indefinite, continuous use as a thruster in very low Earth orbit (VLEO).

In a general aspect, a system for generating thrust includes a thruster body having a funnel and an ion accelerator. The funnel has an opening at a first end of the thruster body and is configured to receive neutral particles and cause ionization of the neutral particles, resulting in corresponding ions and electrons. The ion accelerator extends from the funnel to a second end of the thruster body and is configured to receive the ionized particles from the funnel and cause ejection of the ionized particles from an opening at the second end of the thruster body, generating thrust.

Aspects may include one or more of the following features.

The system may include conductive rings, including a first number of concentrically arranged conductive rings separated by an insulator in the funnel and a second number of concentrically arranged conductive rings separated by an insulator in the ion funnel. The rings of the first number of conductive rings may have decreasing radii as the distance between the rings and the first end of the thruster body increases and the rings of the second number of conductive rings may have substantially constant radii.

The system may include a radio frequency signal generator configured to generate a radio frequency signal that is supplied to the first number of conductive rings and the second number of conductive rings. A phase of the radio frequency signal at any one of the conductive rings may be shifted relative to a phase of the radio frequency signal at conductive rings adjacent to the conductive ring. The phase may be shifted by π radians. The radio frequency signal may cause a radial effective potential near the inner surfaces of the conductive rings. The radial effective potential may cause the ionization of the neutral particles away from the inner surfaces of the conductive rings and toward a central axis of the thruster body. Supplying the radio frequency signal to the conductive rings may cause generation of an electromagnetic sheath around the thruster body. The radio frequency signal may be supplied to the conductive rings through a direct current isolating capacitor array.

The system may include a direct current potential generator configured to apply direct current bias across the first number of conductive rings and the second number of conductive rings to cause a direct current potential along a central axis of the thruster body. The conductive rings may be connected by resistors. The direct current potential may cause acceleration of the ionized particles through the ion accelerator and ejection of the ionized particles from the opening at the second end of the thruster body.

The system may include a solenoid wound along an outside surface of the thruster body, the solenoid configured to generate a magnetic field for guiding the electrons resulting from the ionization of the neutral particles toward the second end of the thruster body where they combine with and neutralize the ejected ionized particles. The solenoid may be wrapped along a length of the thruster body.

The funnel may have an exhaust opening that feeds into the ion accelerator. The funnel may be sized and shaped to cause compression of particles, with a compression ratio defined by a ratio of the funnel's exhaust opening to the opening in the first end of the thruster body. The compression ratio may be in a range of 1 to 20,000. The ion funnel may be configured to cause emission of a quantity of electrons sufficient to neutralize the ejected ionized particles.

In another general aspect, a method for generating thrust using particles in an atmosphere includes ingesting particles into a first end of a thruster body, causing ionization of the particles in the thruster body, the ionization generating ions and electrons, accelerating the ions in the thruster body, causing ejection of the ions from a second end of the thruster body, and guiding the electrons resulting from the ionization of the particles toward the second end of the thruster body where they combine with and neutralize the ejected ions.

Aspects may have one or more of the following advantages.

Among other advantages over conventional ion thrusters, aspects described herein are designed to act as a ram scoop, an ionizer, a compressor, and an electrodeless cathode. This design advantageously provides nearly 100% transport efficiency and generates a short-range virtual potential along an inner surface of the thruster, which creates an electromagnetic sheath that prevents contact between hyperthermal gases (e.g., atomic oxygen) and components of the thruster and eliminates drag, and physical component decay.

Aspects are advantageously propellant agnostic, as they are capable of ionizing several types of gases readily available in the atmosphere. Aspects further obviate the need for capturing and storing atmospheric gases by using a non-thermalizing ionizer with its output connected to a linear ion accelerator.

Aspects are advantageously able to generate thrust across almost the entire VLEO altitude range (i.e., 90-450 km) with an effectively infinite specific impulse. Aspects are similarly able to support very low orbits (VLOs) around other planets and moons with atmospheres (e.g., Mars, Venus, and Titan).

Aspects advantageously generate ions either by capacitive ionization above an inner surface of the ionizer funnel or by DC corona discharge through a length of the thruster to support low and high-altitude operation, respectively, in the same engine, providing a unique solution for a full range of VLEO missions.

Aspects advantageously recycle electrons generated from ionization to neutralize the charge of the thruster by emitting as many electrons as ions, obviating the need for a separate air-breathing, plume neutralizing cathode and increasing system lifetime and reliability.

Aspects advantageously do not require a delicate ion grid, which is prone to damage. Aspects advantageously have minimal impedance matching needs for the ionizer funnel due to the coupling of the opposite polarity waves in every other ring, especially at low f.

Other features and advantages of the invention are apparent from the following description, and from the claims.

### BRIEF DESCRIPTION OF THE DRAWINGS

FIG. 1 is a satellite system.

FIG. 2 is an ion thruster ionizing particles.

FIG. 3 is an ion thruster accelerating ions and neutralizing its exhaust.

FIG. 4 is a schematic diagram of an electrical system of an ion thruster.

FIG. 5A depicts thrust vs. the accelerating voltage of the ion accelerator.

FIG. 5B depicts thrust vs. power draw from the ion accelerator.

FIG. 5C depicts a ratio of thrust and power to the accelerating voltage of the ion accelerator.

FIG. 6 is an alternative embodiment of the ion thruster.

### DETAILED DESCRIPTION

### 1 Overview

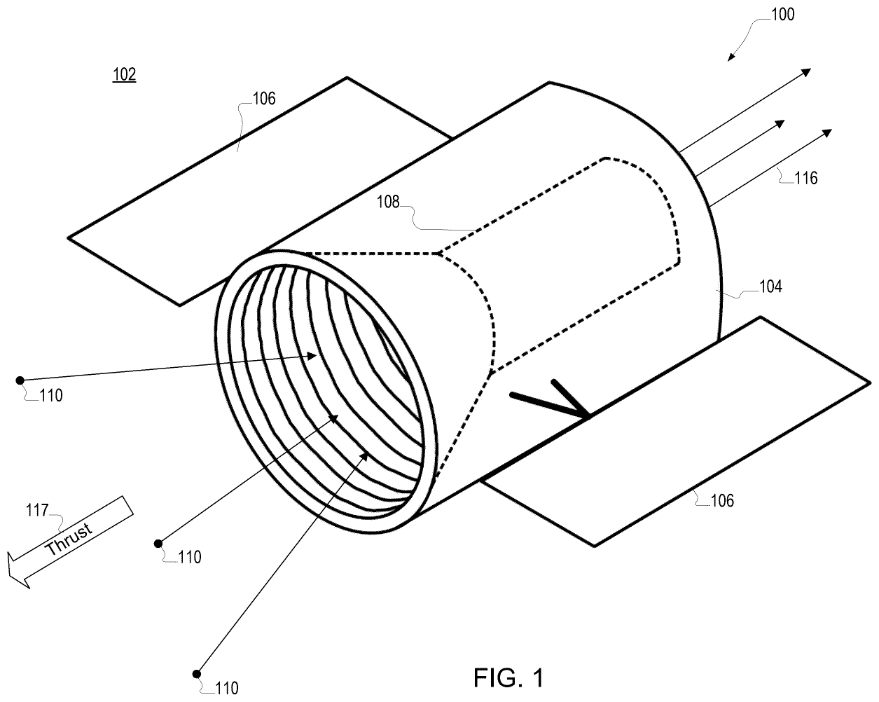

Referring to FIG. 1, a satellite system 100 operating in an atmosphere 102 (e.g., the thin atmosphere of low earth orbit) includes a payload 104, solar panels 106, and an ion thruster 108. The payload 104 includes the components or equipment used to fulfill the satellite system's mission and the solar panels 106 convert sunlight into electrical energy used by the payload 104 and the ion thruster 108.

The ion thruster 108 propels the satellite system 100 for operations such as orbital maneuvers and station keeping. As is described in greater detail below, the ion thruster 108 is designed to generate thrust using particles 110 (e.g., ions and/or neutral particles) scavenged from the atmosphere 102. For example, particles 110 in the atmosphere 102 are ingested by the thruster 108, ionized (unless the particles are ingested as ions), accelerated through the ion thruster 108, and ultimately ejected from the ion thruster 108 as exhaust 116, generating thrust 117.

### 2 Principle of Operation

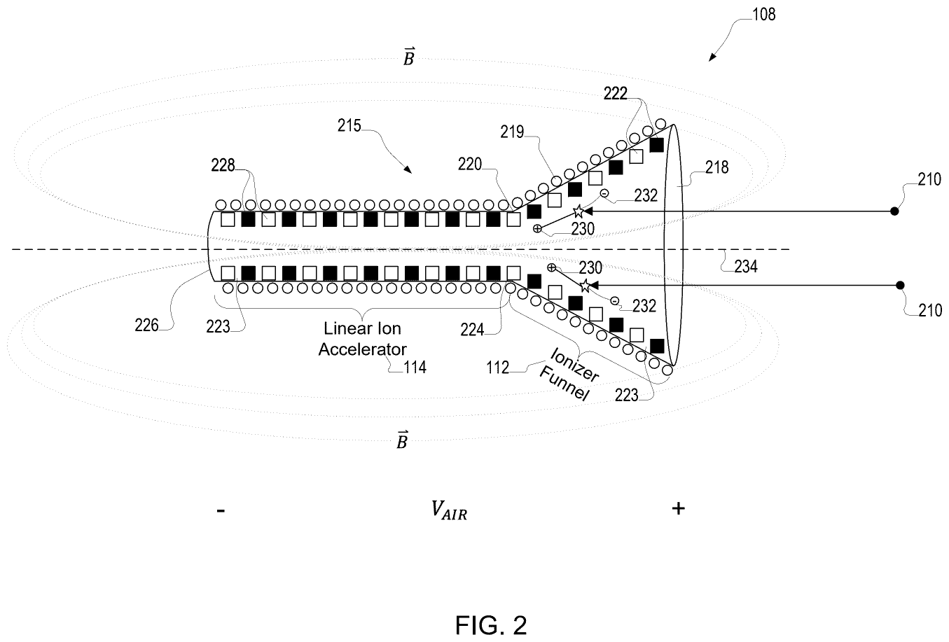

Referring to FIG. 2, in one example, the ion thruster 108 includes a thruster body 215 including an ionizer funnel 112, a linear ion accelerator 114. A solenoid 219 is wrapped around a length of the thruster body 215.

The ionizer funnel 112 includes a funnel opening 218 and a funnel exhaust 220. A first series of concentric conductive rings 222 is disposed between the funnel opening 218 and the funnel exhaust 220, with the conductive rings being separated by an insulating material 223. The diameters of the conductive rings in the first series of conductive rings 222 decrease the further the conductive rings are from the funnel opening 218, resulting in a funnel shape.

The linear ion accelerator 114 includes an accelerator opening 224 and an accelerator exhaust 226, with the funnel exhaust 220 feeding into the accelerator opening 224. A second series of concentric conductive rings 228 is disposed between the accelerator opening and the accelerator exhaust 226, where the conductive rings of the second series of conductive rings 228 are also separated by the insulating material 223. In some examples, unlike the rings of the ionizer funnel 112, the rings of the linear ion accelerator 114 all have substantially the same diameter (i.e., the linear ion accelerator has a constant radius).

As is described in greater detail below, the conductive rings 222, 228 of the ionizer funnel 112 and linear ion accelerator 114 are energized with a radio frequency (RF) signal to generate an electric field in a region near the inner surfaces of the ionizer funnel 112 and the linear ion accelerator 114. The electric field serves to (1) ionize neutral particles and (2) trap ions in the thruster body 215 while preventing the ions from contacting the inner surfaces of the ionizer funnel 112 and the linear ion accelerator 114.

In FIG. 2, neutral particles 210 are shown entering the ionizer funnel 112 and ionizing due to the electric field in regions near the inner surface of the ionizer funnel 112. Each ionization event generates an ion 230 that is captured by the electric field and an electron 232.

A direct current (DC) bias is also applied to the conductive rings 222, 228, causing a DC electric potential (V_{AIR}) along a length of the thruster body 215. The DC electric potential causes the ions 230 to be pulled toward the ionizer funnel exhaust opening 220 and also causes the ejection of the electrons 232 from the funnel opening 218. Due to the funnel shape of the ionizer funnel 112, the ions 230 are compressed as they are pulled toward the ionizer funnel exhaust opening 220.

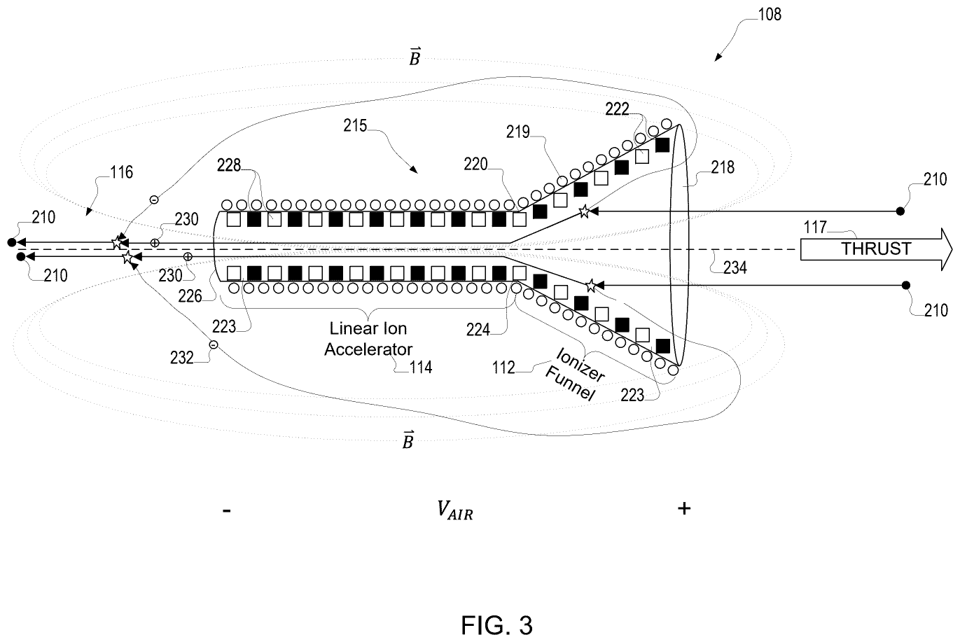

Referring to FIG. 3, the DC electric potential further causes the ions 230 to enter the linear ion accelerator 114, where they are accelerated by the DC electric potential. As the ions 230 travel along the linear ion accelerator 114, the electric field generated by the conductive rings 228 forces the ions 230 away from the inner surface of the linear ion accelerator and toward a central axis 234 of the thruster body 215. The ions 230 are ultimately ejected from the accelerator exhaust opening 226 as exhaust 116, generating thrust 117 characterized as T=m\dot{v} where m is the ion mass and \dot{v} the acceleration of the ions added by the linear ion accelerator 114.

The positively charged ions in the exhaust 116 tend to cause a buildup of negative charge on the ion thruster 108 (or a spacecraft including the ion thruster) that would eventually create an electrostatic attraction between the ion thruster and the expelled ions, interfering with the thruster's performance. The solenoid 219 wound around the thruster body 215 generates a magnetic field, [symbol] that captures the electrons 232 ejected from the ionizer funnel 112 and guides them to the exhaust 116, where they combine with and re-neutralize the accelerated ions in the exhaust, preventing the buildup of negative charge on the ion thruster.

In general, electrons are recycled, but not ions, due to the much lower mass of electrons. In some examples, the axial magnetic field generated by the solenoid also serves to aid the compression and confinement of ions inside the ion thruster 108.

### 3 Thruster Design

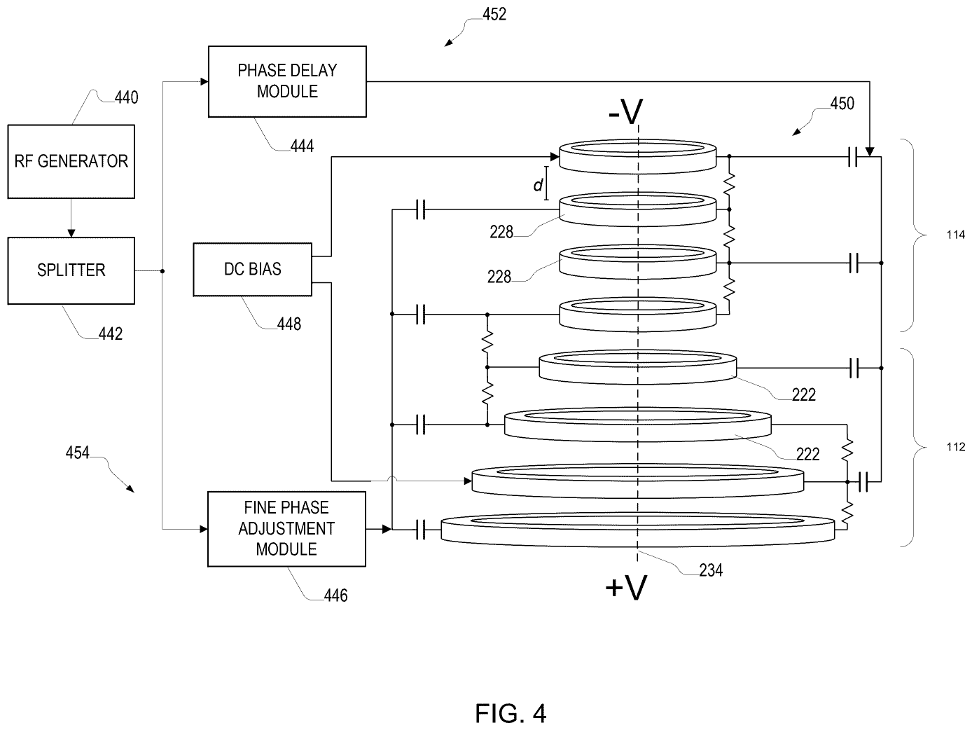

Referring to FIG. 4, and as is described above, the ion thruster 108 includes the ionizer funnel 112 and the linear ion accelerator 114, which are formed using a stack of concentrically arranged conductive (e.g., metal) rings 222, 228, separated by a distance, d (e.g., d<1.0−0.5 mm). In some examples, the ion thruster 108 also includes an RF generator 440, a signal splitter 442, a phase delay module 444, a fine phase adjustment module 446, a DC bias module 448, and a resistor-capacitor (RC) network 450.

### 3.1 Ion Generation and Transport

In the example of FIG. 4, the conductive rings 222, 228 are excited with both an RF signal and a DC bias such that ions can be generated by capacitive ionization and/or DC corona discharge. The RF generator 440 supplies RF signal to the conductive rings 222, 228 through signal splitter 442, phase delay module 444, fine phase adjustment module 445, and RC network 450 to generate an electric field above the inner surface of the conductive rings 222, 228. As is mentioned above, the electric field serves to both ionize neutral particles in the ionizer funnel and prevent ions from reaching the inner surface of the conductive rings (i.e., due to a high positive field gradient near the inner surface), where they can cause damage.

The DC bias module 448 causes a DC potential, V_{AIR} across the conductive rings 222, 228, which causes an electric field to accelerate ions through the ionizer funnel 112 and linear ion accelerator 114, ultimately emitting the ions as the exhaust 116 and generating thrust 117.

In some examples, the RF generator 440 generates a sinusoidal oscillating potential with a peak-to-peak voltage, Vₚₚ. The signal generated by the RF generator 440 is output to the signal splitter 442, which splits the signal into two paths such that the signal is applied with equal magnitude to all the conductive rings, but opposite phase is applied to adjoining conductive rings.

For example, a first path 452 includes the phase delay module 444 that imparts a 180-degree (i.e., π) phase delay to the signal before the signal is provided to every other one of the conductive rings via the RC network 450. Similarly, a second path 454 includes the fine phase adjustment module 446 that imparts a fine-grained delay to the signal before the signal is provided to the remaining conductive rings via the RC network 450. The fine-grained delay is used to precisely balance the phases of the oscillator rings to ensure that they remain exactly 180 degrees (i.e., π) out of phase.

In some examples, the RC network 450 acts as a DC-isolating capacitor array. For example, the RF power is applied to the rings through the DC-isolating capacitor array (where capacitors act as open circuits at DC), while the rings are connected to each other in series via high-Ohm resistors to support the axial DC potential, V_{AIR} which becomes progressively more negative to draw ions through through the thruster and accelerate them. It is noted that, in some examples, alternate but equivalent realizations of the circuit shown in FIG. 4 can be used.

### 3.1.1 Radial Effective Potential

This arrangement produces a radial effective potential, V_{rad} above the inner surface of the conductive rings 222, 228 that falls rapidly to zero near the central axis 234. In some examples, the radial effective potential is defined as:

$${V}_{r a d} = \frac{{z}_{i} e {V}_{p p}^{2}}{32 {m}_{i} {f}^{2} {d}^{2}} [ Volts ]$$

where zᵢ is the ion charge (we assume zᵢ=1 henceforth), e is the electron charge, mᵢ is the ion mass (assumed 16 amu for most very low earth orbit calculations), and f is the oscillator frequency of the RF generator 440.

In some examples, the oscillator frequency, f of the RF generator 440 is greater than or equal to 1 MHz, and the peak-to-peak voltage of the RF signal, Vₚₚ is approximately 1 kV to ensure efficient RF ionization of incoming gases. In one particular example, the RF generator 440 uses a 600 W, 13.56 MHz signal generator, sufficient to ionize, trap and compress incoming neutral particles. In other examples, a lower f and a higher Vₚₚ oscillator can be used.

### 3.1.2 Axial Potential

In addition to the radial effective potential, V_{rad} there is an axial potential, V_{fun}, trapping ions in the ionizer funnel 112 and drawing them toward the ionizer funnel exhaust opening. In some examples, the axial potential in the ionizer funnel 112 is defined as:

$${V}_{fun} = \frac{{V}_{r a d}}{{I}_{0}^{2} ( \frac{r}{d} )} \pm {V}_{a x}$$

where I₀ is the zero-order modified Bessel function and Vₐₓ is a DC potential applied down the length of the ionizer funnel 112. There is also a DC axial potential, V_{guide} applied down the length of the linear ionizer funnel 114, with the overall potential drop from stem to stern of the ion thruster 108, caused by the DC bias module 448, being V_{AIR}=Vₐₓ+V_{guide}.

In some examples, (V_{rad}, V_{fun})>12 V is sufficient to prevent collisions with the funnel as ion energies in very low earth orbit are of order 12 eV or less.

### 3.1.3 Compression and Plasma Generation

In some examples, the ion thruster 108 can generate ions and thrust using DC corona discharge in addition to RF-based capacitive ionization (e.g., based on factors such as altitude). For example, ions in the ionizer funnel 112 are pulled further into the funnel by the DC axial potential and are compressed due to the decreasing radius of the ionizer funnel as the ions approach the funnel exhaust 220.

In some examples, the ionizer funnel 112 has a compression ratio, χ, defined by the geometric ratio of the funnel opening 218 to the funnel exhaust 220 that is defined as follows:

$$χ = \frac{{A}_{i n}}{{A}_{out}} = \frac{{r}_{i n}^{2}}{{r}_{out}^{2}} , {r}_{out} ≫ d$$

where the condition that the outlet radius, rₒᵤₜ is wider than the inter-plate spacing, d guarantees good transmission of low-mass ions.

For example, for rᵢₙ=25 cm and rₒᵤₜ=0.5 cm, the compression ratio χ=2500. In some examples, compression ratios of 1-20,000 are achievable with this configuration regardless of whether the ions form a plasma. Note, too, that the funnel can in principle be square or elliptical with entrance and/or exit apertures “oval-shaped” with radii r replaced by semi-major and semi-minor axes.

In general, an RF plasma will ignite (assuming an ignition particle density threshold of ˜10¹⁹ cm⁻³ and adequate χ) in the “throat” of the ionizer funnel 112 by compressed ions at altitudes up to at least 250 km. At higher altitudes, the sustainment of existing plasma is maintained by the overall DC potential, V_{AIR}. According to Paschen's law, V_{fun} [symbol] 5 torr·cm=5 pₑₓₜχL for plasma ignition (with pₑₓₜ being the external pressure and L the thruster length), meaning that for V_{fun}˜1 kV, a thruster of length L≥1 m and sufficient χ can ignite a DC plasma up to at least 350 km altitude. Note that L>>λ_{D}, the Debye length for thermospheric electrons. In general, for efficient operation at all altitudes of VLEO, it is advisable to choose L, d and the size of the funnel opening 218 to allow a smooth transition from RF to DC plasma support.

Other methods of ionization could include (but are not limited to) hard ionization techniques like electron impact ionization, glow discharge field desorption, fast atom bombardment, thermospray, laser ionization, arc discharge ionization, desorption/ionization on silicon or other materials, triple point ionization, spark ionization, radioisotope ionization utilizing alpha, beta or fission fragments, and thermal (cathodic filament) ionization as well as soft ionization techniques like fast atom bombardment, chemical ionization, atmospheric-pressure chemical ionization, atmospheric-pressure photoionization, electrospray ionization, desorption electrospray ionization, and matrix-assisted laser desorption/ionization. These techniques could be used separately or in combination with one another.

At lower altitudes, the funnel shape of the intake is sufficient to passively compress incoming gases such that a local pressure of order 10⁻² torr is produced near the throat of the funnel. This pressure is sufficient to ignite a plasma by capacitive (RF) or DC corona discharge which, once ignited, may be sustained at significantly lower pressures down to e.g. down to 10⁻⁷ torr. These ambient pressures encompass the better part of the natural VLEO environment on Earth.

### 3.2 Electron Recycling

As is mentioned above, in some examples, the solenoid 219 generates a magnetic field that directs electrons out of the ionizer funnel 112 and guides them to the exhaust 116 of the thruster 108 to prevent a buildup of negative charge on the ion thruster 108.

In some examples, the DC potential, V_{AIR} places a lower bound on the strength of the magnetic field, \vec{B} generated by the solenoid, as the magnetic field should be strong enough to capture the most energetic electrons emitted from the thruster. In some examples, this closing of the plasma circuit around the ion thruster enables cathodeless operation. Per the Lorentz force, 2eV_{AIR}=|v∥B|, with e the electron charge, the required power of the solenoid is defined as:

$${P}_{s} \geq \frac{4 π {m}_{e} {V}_{AIR} 〈 {R}_{AIR} 〉 {ρ}_{w}}{e {μ}_{0}^{2} N {R}_{w}^{2}} = ζ \frac{{ρ}_{w} {V}_{AIR} 〈 {R}_{AIR} 〉}{N {R}_{w}^{2}} [ W ]$$

where mₑ is electron mass, N is the number of turns in the solenoid, μ₀ is the magnetic permeability, R_{w} and [symbol] R_{AIR} [symbol] are respectively the wire and average solenoid radii, ρ_{w}=ρ_{Cu} is the resistivity of copper and ζ=4πmₑ/eμ₀² (where the free-fall velocity of the electrons, v=\sqrt{2eV_{AIR}/mₑ} is used).

In some examples, values for N and R_{w} of 500 and 1 mm, respectively, yield a power draw of <5 W for V_{AIR}=1 kV and <40 W for V_{AIR}=10 kV, leaving spare capacity to counter the Earth's local magnetic field, which may be required in certain circumstances.

### 3.3 Thrust

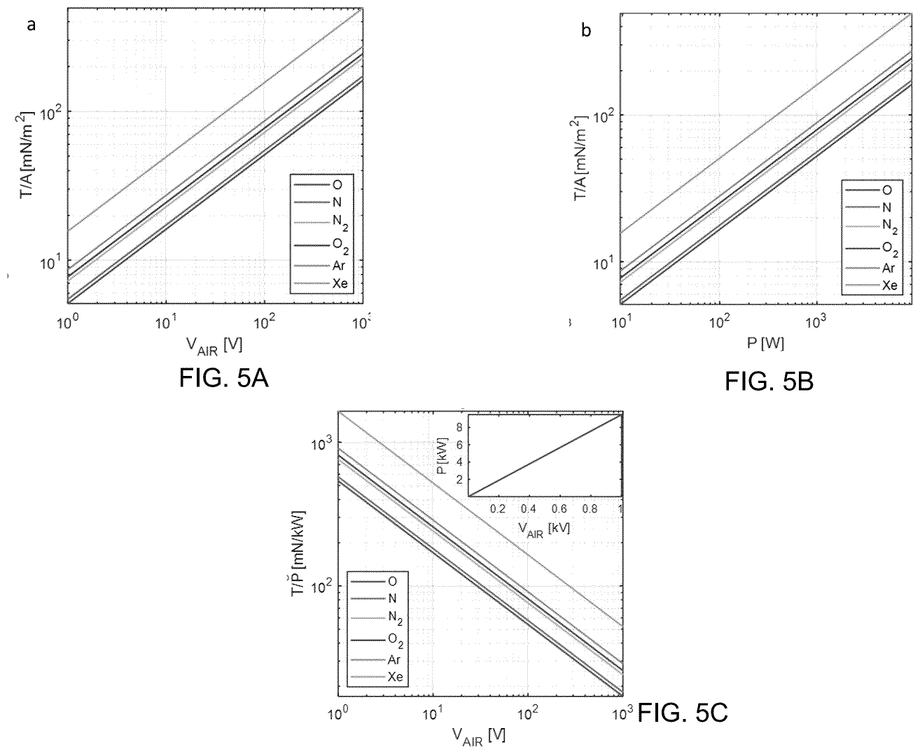

FIGS. 5A-5C depict graphs related to the performance of the ion thruster. FIG. 5A depicts thrust vs. the accelerating voltage of the ion accelerator. FIG. 5B depicts thrust vs. power draw from the ion accelerator. In FIGS. 5A and 5B, “A” refers to the cross-sectional area of an entrance of the ion accelerator. FIG. 5C depicts a ratio of thrust and power to the accelerating voltage of the ion accelerator.

In some examples, the thrust, T generated by the ion thruster 108 is calculated by equating the input mass rate gathered from the atmosphere, \dot{m}=nₐₜₘv_{orb}Aᵢₙ, to the ion mass current ejected from the thruster, \dot{m}e=jAₒᵤₜm, with A_{in/out} being the thruster input and output cross-sectional areas, nₐₜₘ being the particle density as a function of altitude (˜10¹⁶ m⁻³ at 200 km altitude), and v_{orb} being the orbital velocity of the craft (˜7.4 km/s).

Solving for j and inserting into the relevant equation for electrostatic thrust (T=jAₒᵤₜ\sqrt{2mV_{AIR}/e}) the thrust density [symbol] is:

$$ℱ = \frac{T}{{A}_{i n}} = {n}_{atm} {v}_{o r b} η \sqrt{2 m e {V}_{AIR}} [ N / {m}^{2} ]$$

where η is the overall thruster efficiency including all contributions. Referring to FIG. 5A, using η=0.8, and V_{AIR}=1 kV, a total [symbol] >100 mN/m² is achievable in pure ducted air-breathing mode at ˜200 km altitude.

The specific impulse Iₛₚ of the ion thruster warrants careful definition. In terms of unit mass of fuel consumed, an ideal “single-aperture” gridded ion thruster has

$${I}_{s p} = \sqrt{\frac{2 e {V}_{AIR}}{{m}_{i} {g}^{2}}} [ s ]$$

which, using the same figures as above and g=9.8 m/s² (the acceleration due to gravity at the Earth's surface), implies an Iₛₚ>10⁴ s, an order of magnitude higher than conventional Hall or gridded ion Xenon propellant thrusters. Higher accelerating potentials may reach Iₛₚ˜10⁵ s with higher V_{AIR}. At much higher V_{AIR}, (>200 keV) relativistic effects on the ejected propellant become relevant. On the other hand, as a matter of quantifying the fuel-efficiency of the thruster in terms of maximum achievable Δv, because no on-board propellant is expended, mᵢ=0 can be considered, rendering Iₛₚ effectively infinite, meaning the thruster can in practice be run indefinitely. The total impulse, Iₜₒₜ=Δt·T, is similarly infinite for Δt→∞. The prevention of contact between gases at very low orbit (e.g., VLEO) and engine components makes this feasible in practice.

### 4 Alternatives

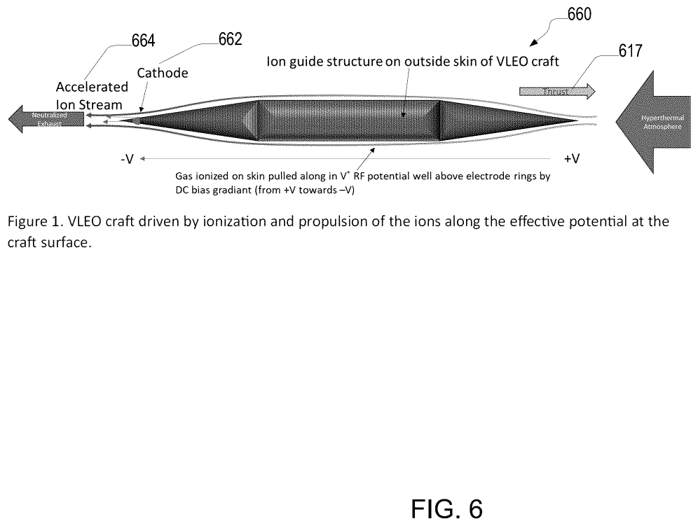

Referring to FIG. 6, in an alternative example, the ion thruster 608 is inverted to be on the exterior of a spacecraft 660. For example, the ion thruster 608 is realized by lining the outer mold line of a spacecraft with electrodes spaced by insulators. The electrodes are energized with a high-power RF signal, alternating in phase for each electrode, and a gradient in DC potential that becomes more negative progressively toward the rear of the craft. Neutral particles approaching the spacecraft surface are ionized and some of the ions are trapped in a potential well some distance above the skin of the spacecraft 660, then pulled down the length of the craft by a gradually more negative DC potential. Ions ejected from the back of the craft are neutralized by a cathode 662. The ejected ion stream 664 provides thrust 617 proportional to the gain in the ion velocity. In some instances, a pulsed DC gradient traveling down the length of the craft, rather than a static DC potential gradient down the length of the craft, may be used to accelerate ions along the length of the thruster.

In some examples, the solenoid and associated magnetic field described above are omitted. In such examples, charge neutrality can be maintained by forward emission of a number of electrons equal to the number of ions accelerated and emitted to generate thrust.

In some examples, the insulator material separating the conductive rings can also serve as the resistors in the RC network.

In some examples, the conductive rings may be stacked in a direction that is non-orthogonal to the direction of capture of particles such that particles are less likely to be trapped between the conductive rings.

In some examples, the materials that are used within the funnel include ultra-flat surfaces (e.g., graphene, borophene, goldene, MXenes, ultra-flat stripped gold, or a thin metal oxide 2D material), atomic oxygen-resistant materials, or combinations of those materials. It should be appreciated that different materials may be chosen based on the environment in which the thruster operates. In some examples, the inner surface of the ionizer funnel is lined with ultra-flat tiles, where different tiles may have different material properties and/or are fabricated using different materials. Additional details and embodiments related to the materials used can be found in U.S. patent application Ser. No. 18/826,843, filed Sep. 6, 2024, and titled “System and Process for the Additive Manufacturing of RF Tunable Materials,” the entire contents of which are hereby incorporated by reference.

In the above description, the ion thruster is described as operating at low earth orbit or very low earth orbit (VLEO). However, it should be recognized that the ion thruster can operate in any environment where the atmosphere is suitable (e.g., where the density of particles is sufficient to generate thrust). For example, the ion thruster can operate in orbit around other celestial bodies or even in free space if a suitable atmosphere is present.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent and thus can be performed in an order different from that described.

What is claimed is:

1. A system for generating thrust, the system comprising:
a thruster body having
a funnel with an opening at a first end of the thruster body, the funnel configured to receive neutral particles and cause ionization of the neutral particles, resulting in corresponding ions and electrons, and
an ion accelerator extending from the funnel to a second end of the thruster body, the ion accelerator configured to receive the ionized particles from the funnel and cause ejection of the ionized particles from an opening at the second end of the thruster body, generating thrust.

2. The system of claim 1 wherein the system includes a plurality of conductive rings, including a first plurality of concentrically arranged conductive rings separated by an insulator in the funnel and a second plurality of concentrically arranged conductive rings separated by an insulator in the ion funnel.

3. The system of claim 2 wherein the rings of the first plurality of conductive rings having decreasing radii as the distance between the rings and the first end of the thruster body increases and the rings of the second plurality of conductive rings have substantially constant radii.

4. The system of claim 2 further comprising a radio frequency signal generator configured to generate a radio frequency signal that is supplied to the first plurality of conductive rings and the second plurality of conductive rings.

5. The system of claim 4 wherein a phase of the radio frequency signal at any one of the conductive rings is shifted relative to a phase of the radio frequency signal at conductive rings adjacent to the conductive ring.

6. The system of claim 5 wherein the phase is shifted by π radians.

7. The system of claim 4 wherein the radio frequency signal causes a radial effective potential near the inner surfaces of the conductive rings.

8. The system of claim 7 wherein the radial effective potential causes the ionization of the neutral particles away from the inner surfaces of the conductive rings and toward a central axis of the thruster body.

9. The system of claim 7 wherein supplying the radio frequency signal to the conductive rings causes generation of an electromagnetic sheath around the thruster body.

10. The system of claim 4 wherein the radio frequency signal is supplied to the conductive rings through a direct current isolating capacitor array.

11. The system of claim 2 further comprising a direct current potential generator configured to apply direct current bias across the first plurality of conductive rings and the second plurality of conductive rings to cause a direct current potential along a central axis of the thruster body.

12. The system of claim 11 wherein the conductive rings are connected by resistors.

13. The system of claim 11 wherein the direct current potential causes acceleration of the ionized particles through the ion accelerator and ejection of the ionized particles from the opening at the second end of the thruster body.

14. The system of claim 1 further comprising a solenoid wound along an outside surface of the thruster body, the solenoid configured to generate a magnetic field for guiding the electrons resulting from the ionization of the neutral particles toward the second end of the thruster body where they combine with and neutralize the ejected ionized particles.

15. The system of claim 14 wherein the solenoid is wrapped along a length of the thruster body.

16. The system of claim 1 wherein the funnel has an exhaust opening that feeds into the ion accelerator.

17. The system of claim 14 wherein the funnel is sized and shaped to cause compression of particles, with a compression ratio defined by a ratio of the funnel's exhaust opening to the opening in the first end of the thruster body.

18. The system of claim 15 wherein the compression ratio is in a range of 1 to 20,000.

19. The system of claim 1 wherein the ion funnel is configured to cause emission of a quantity of electrons sufficient to neutralize the ejected ionized particles.

20. A method for generating thrust using particles in an atmosphere, the method including:
ingesting particles into a first end of a thruster body;
causing ionization of the particles in the thruster body, the ionization generating ions and electrons;
accelerating the ions in the thruster body, causing ejection of the ions from a second end of the thruster body; and
guiding the electrons resulting from the ionization of the particles toward the second end of the thruster body where they combine with and neutralize the ejected ions.
